(19) United States
(12) Patent Application Publication
(10) Pub. No.: US 2007/0089172 A1
(43) Pub. Date: Apr. 19, 2007

(54) Methods for identifying self-replicating threats using historical data

(76) Inventors: Ballard C. Bare, Auburn, CA (US); Daniel E. Ford, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,664

(22) Filed: Oct. 14, 2005

(51) Int. Cl. G06F 12/14

(52) U.S. Cl. 726/24

(57) ABSTRACT

A computer-implemented method of ascertaining an infected node in a network of nodes. The computer-implemented method includes providing a repository for storing network flow data among at least a plurality of the nodes. The repository is operatively coupled to the network to permit the repository to acquire the network flow data. The computer-implemented method also includes storing at the repository first network flow data among the at least a plurality of nodes. The first network flow data includes a plurality of source addresses and corresponding destination addresses for a plurality of data flows. The computer-implemented method further includes analyzing the first network flow data at the repository to ascertain communication abnormalities that indicate whether any of the plurality of nodes is infected.

### BACKGROUND OF THE INVENTION

Advances in the computer and electronic industries have propagated the exchange of electronic information. Modern society has enthusiastically embraced the internet and intranet as a quick and efficient method of sharing information. Inadvertently, the dependence upon electronic exchange has also created a large complex network of users susceptible to malicious attacks from electronic self-replicating threats.

As discussed herein, self-replicating threats (SRTs) refer to malicious computer codes that may be loaded onto a device without the user's consent. Also, the SRTs may be capable of duplicating themselves and/or infecting other files. SRTs may include, but are not limited to, viruses, worms, and blended threats. In an example, SRTs may be executable files that may or may not require a user's intervention to be executed before the computer is infected. Since a user with an infected device (e.g., computers, printers, hard drives, networks, etc.) may be unaware of the SRTs existence, the user may unknowingly assist the proliferation of the SRTs to other devices through program or file sharing.

As discussed, some SRTs may spread to other devices without any intervention or assistance from a user. Instead, the SRTs may take advantage of available device transport features to travel unassisted to other devices. Consequently, SRTs may have the ability to quickly self-replicate on a host device (i.e., current infected device) and to send out an unlimited number of duplicate SRTs throughout the network, creating a catastrophic effect.

To facilitate discussion, FIG. 1 shows a simple block diagram of a network with four switches. Network 102 includes four switches (104, 106, 108, and 110). Attached to switch 104 are nodes 112 and 114. Attached to switches 106 and 108 are nodes 116 and 118, respectively. Also, attached to switch 110 are nodes 120 and 122. The various nodes may communicate with one another by sending data packets throughout the network. In an example, node 112 may communicate with node 122. A data packet may be sent from node 112 via switch 104 to node 122 via switch 110. Inside the data packet may be the source address (node 112) and the destination address (node 122).

Within a given day, a plethora of data packets may be sent between the nodes throughout the network. If SRTs are attached to one or more of the data packets that may be traversing through the network, the SRTs may have spread throughout the network before the users and/or administrators may have an opportunity to identify and eradicate the SRTs.

Consider the situation wherein, for example, a SRT may be attached as a document file on an email that is being sent to a number of recipients. Each recipient may unknowingly spread the SRT to other computers by forwarding a seemingly innocent email. Further, if the SRT is capable of accessing each recipient's address book, the SRT may be able to take advantage of the network transport features to send out a plethora of infected emails to unsuspecting recipients.

One method for dealing with SRTs is to prevent the SRTs from infecting the device. Generally, the user may become aware of the SRTs through suspicious or unusual device behavior/output and/or through warnings from monitoring and blocking software (e.g., anti-virus program). In an example, users may receive unsolicited emails mimicking a known email address with suspicious attachments. The user may have pre-programmed all incoming email attachments to be checked by a monitoring and blocking software, which may identify attachments that may have potential SRTs, thereby forewarning users of potential threats. However, the aforementioned methods may be limited to identifying known SRTs and may be ineffective in detecting unknown or new SRTs.

Prior art solution may also provide for a software program to identify suspicious behavior. The purpose of the software program is to alert the user to any potential SRTs (both known and unknown). However, the software program may alert the user of behaviors that the software program may identify as unusual, resulting in a large number of warnings. Consequently, the user may become desensitized to the warnings and ultimately ignore all warnings. Hence, the software program intended to help users identify potential SRTs may become ineffective.

In addition, prior art solution may not provide for a method that may pro-actively allow network administrator identify devices that may have abnormal behaviors. In the example above, the user may receive an email with an SRT attached. The SRT may have the capability of accessing the user's address book and replicating itself and sending out a plethora of infected emails to unsuspecting recipients. The high volume of emails that the user's computer may generate may go undetected since a method may not exist to identify high risk behavior on the infected device.

In situations in which the SRTs may have infected a device, the user may first have to isolate the device before utilizing software capable of eliminating the SRT. If the infected device is part of a network, then the users/administrators may have the painstaking task of identifying other devices that may have been attacked by the SRTs.

### SUMMARY OF INVENTION

The invention relates, in an embodiment, to a computer-implemented method of ascertaining an infected node in a network of nodes. The computer-implemented method includes providing a repository for storing network flow data among at least a plurality of the nodes. The repository is operatively coupled to the network to permit the repository to acquire the network flow data. The computer-implemented method also includes storing at the repository first network flow data among the at least a plurality of nodes. The first network flow data includes a plurality of source addresses and corresponding destination addresses for a plurality of data flows. The computer-implemented method further includes analyzing the first network flow data at the repository to ascertain communication abnormalities that indicate whether any of the plurality of nodes is infected.

In yet another embodiment, the invention relates to an article of manufacture comprising a program storage medium having computer readable code embodied therein. The computer readable code is configured to ascertain an infected node in a network of nodes. The article includes computer readable code for storing at a repository first network flow data among the at least a plurality of nodes. The first network flow data includes a plurality of source addresses and corresponding destination addresses for a plurality of data flows. The article also includes computer readable code for analyzing the first network flow data at the repository to ascertain communication abnormalities that indicate whether any of the plurality of nodes is infected.

In yet another embodiment, the invention relates to a network of nodes having threat diagnostic capability for ascertaining an infected node in the network of nodes. The network includes a repository operatively coupled to the network to permit the repository to acquire the network flow data. The network also includes logic circuitry for storing at the repository first network flow data among at least a plurality of nodes of the nodes. The first network flow data includes a plurality of source addresses and corresponding destination addresses for a plurality of data flows. The network further includes logic circuitry for analyzing the first network flow data at the repository to ascertain communication abnormalities that indicate whether any of the plurality of nodes is infected.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple block diagram of a network with four switches.

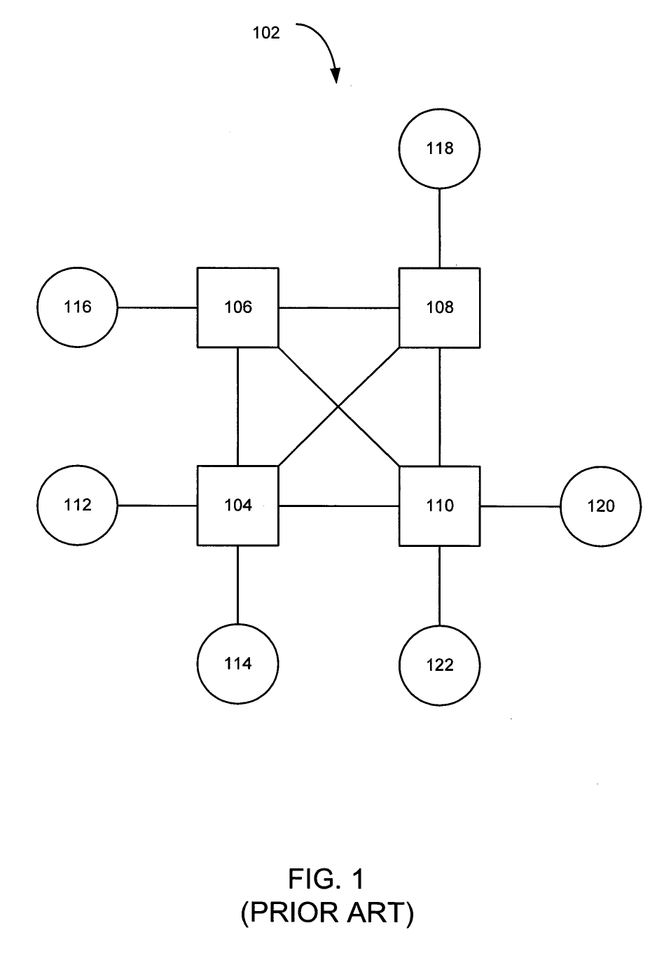

FIG. 2 shows, in an embodiment of the present invention, a block diagram of a simple network with a forensic historical repository (FHR).

FIG. 3 shows, in accordance with an embodiment of the present invention, a flowchart illustrating the steps to collect, filter and store flow data in a FHR.

FIG. 4 shows, in accordance with an embodiment of the present invention, a diagram illustrating a simple snapshot of blocks of flow data in a FHR.

FIG. 5 shows, in accordance with an embodiment of the present invention, a diagram illustrating the suspect source and the affected trail from flow data in a FHR.

FIG. 6 shows, in accordance with an embodiment of the present invention, a flowchart illustrating how a FHR may be used to track affected trails and to apply remedial action to the affected nodes.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

In accordance with embodiments of the present invention, there is provided an arrangement in which a forensic historical repository (FHR) provides a database for acquiring, maintaining, and/or integrating network flow data. Embodiments of the invention also provide for the FHR to facilitate the task of identifying and tracking primary suspect nodes that may be infected by self-replicating threats (SRTs). As discussed herein, a primary suspect node refers to a node from which the source of a SRT may first be identified. Also, as discussed herein, a FHR refers to a database that may include, but are not limited to, flow data about the nodes in the network. Examples of a node may include, for example, a computer, printer, or any device that may have a unique network address.

In an embodiment, an assortment of data may be collected for the FHR to allow for forensic analysis. The data collected for the FHR may be performed by a network management station (NMS). As discussed herein, a NMS refers to a network management protocol that enables network flow data (e.g., source address, destination address, timestamp, etc.) to be gathered. Examples of NMS may include, but are not limited to, sFlow, remote monitoring (RMON), simple network management protocol (SNMP), and Hewlett-Packard™ Extended RMON.

Initially, the flow data may be stored on the network switches. The flow data may be pushed up to or be pulled by the NMS. In an example, a data packet may traverse multiple switches before reaching its destination. Each of the switches, upon handling the data packet may store information about the flow ID. When the flow data is retrieved by or pushed to the NMS, multiple incidents of the same flow data may be stored by the NMS. To prevent the FHR from becoming unnecessarily large, the NMS may remove duplicate entries.

In an embodiment, the NMS may take a snapshot of the network flow data at a block of time and may store the flow data in the FHR. The granularity of the time period during collection of the flow data may be determined by the users/administrators. This may be made based on the system available storage space, the amount of traffic on the system, and/or the size of the network.

With a FHR, users/administrators may be able to proactively search for SRTs. In an example, an atypical high level of traffic may be occurring on a node. Users/administrators may analyze the node (such as using an intrusion detection system) to determine if the node may be infected by a SRT. Once a SRT has been confirmed, the users/administrators may methodically perform forensic analysis on the historical data stored on the FHR to determine the affected trail.

In an embodiment, forensic analysis may be performed by analyzing the repository of flow data to determine the primary suspected node and the time period that the attack may have happened. The flow data of the primary suspected node may be examined to determine the communication flows during the suspected time period to determine the affected trail, i.e. nodes in communication with the primary suspected node. Remedial actions may be performed on the primary suspected node and/or the affected trails to eliminate the SRT. Additionally, if the SRT is assessed to be severe, a more in-depth forensic analysis may be conducted to identify and track further affected trail for remedial actions.

In an embodiment, an in-depth forensic analysis may be performed in reverse order to determine how the primary suspect node may have been infected. The FHR may provide the data needed to allow the users/administrators to trace the infection back to the source (i.e., “patient zero”).

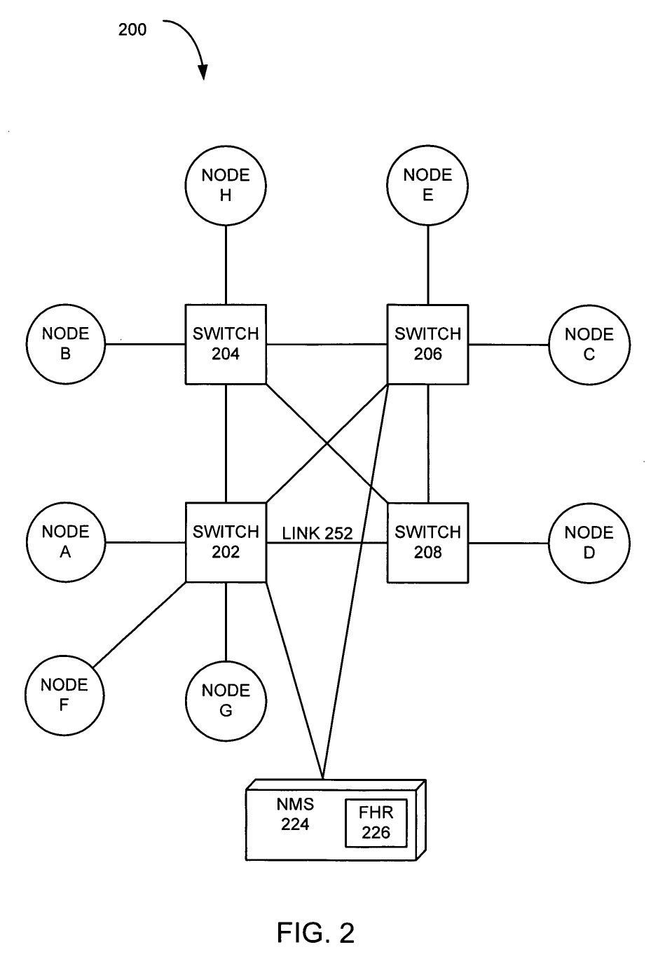

The features and advantages of embodiments of the invention may be better understood with reference to the figures and discussions that follow. FIG. 2 shows, in an embodiment of the present invention, a block diagram of a simple network with a forensic historical repository (FHR). Network 200 may include four switches (202, 204, 206, and 208). Attached to switch 202 may be nodes A, F, and G. Attached to switch 204 may be nodes B and H. Attached to switch 206 may be nodes E and C. Also, attached to switch 208 may be node D.

Consider the situation wherein, for example, a user at node A may send an email to a user at node D. Before being routed through the network, the email may be broken into data packets, each with the same flow identification (ID). As discussed herein, a flow ID refers to a source and destination address pair. In routing the data packet from node A to node D, the data packet may be routed along the most efficient flow path based on congestion or traffic flow on the network. As discussed herein, a flow refers to a communication session between two nodes.

In an example, one data packet may be sent from node A on switch 202 directly to node D on switch 208 via link 252 while another data packet with the same flow ID may flow from switch 202 to switch 204 to switch 206 before arriving at switch 208. Various permutations may exist to deliver the data packets from the source (node A on switch 202) to the destination (node D on switch 208).

In an embodiment, a network management station (NMS) 224 may take a snapshot of the network flow at a point in time and may store the flow data (e.g., the source address, destination address, date and time, etc.) in a FHR 226. As discussed herein, NMS refers to a network management protocol that enables network flow data to be gathered. Examples of NMS may include, but are not limited to, sFlow, remote monitoring (RMON), simple network management protocol (SNMP), and Hewlett-Packard™ Extended RMON. An assortment of data (e.g., source address, destination address, timestamp, etc.) may be collected to allow for forensic analysis.

Initially, the flow data may be stored on the network switches and may be pushed up to or be pulled by NMS 224. In an embodiment, duplicate entries for the node flow data may be filtered out from FHR 226. In an example, a data packet may traverse switches 202, 204, and 208 before arriving at its destination. Each of the switches, upon handling the data packet may store information about the flow ID. When the flow data is retrieved by or pushed to NMS 224, multiple incidents of the same flow data may be stored by NMS 224 onto FHR 226. To prevent FHR 226 from becoming unnecessarily large, NMS 224 may delete duplicate entries.

Although, a FHR with a complete record of network flow data may be desirable, resource limitation (e.g., memory space) may cause the FHR to be less than complete. The granularity of the data (i.e., how often the data is collected) collected may be dependent upon the administrators. In an example, if NMS 224 takes a snapshot of the network flow every 1 minute, then there may be 60 data snapshots per hour. Increasing or decreasing the data sampling frequency tends to increase or decrease the snapshot data storage requirement correspondingly. Further, to consolidate data and minimize storage space, NMS 224, in an embodiment, may limit the flow data collected by storing and/or maintaining communications between “top talkers.” As discussed herein, “top talkers” refer to nodes that may have high traffic volume (i.e., volume of interaction with other nodes).

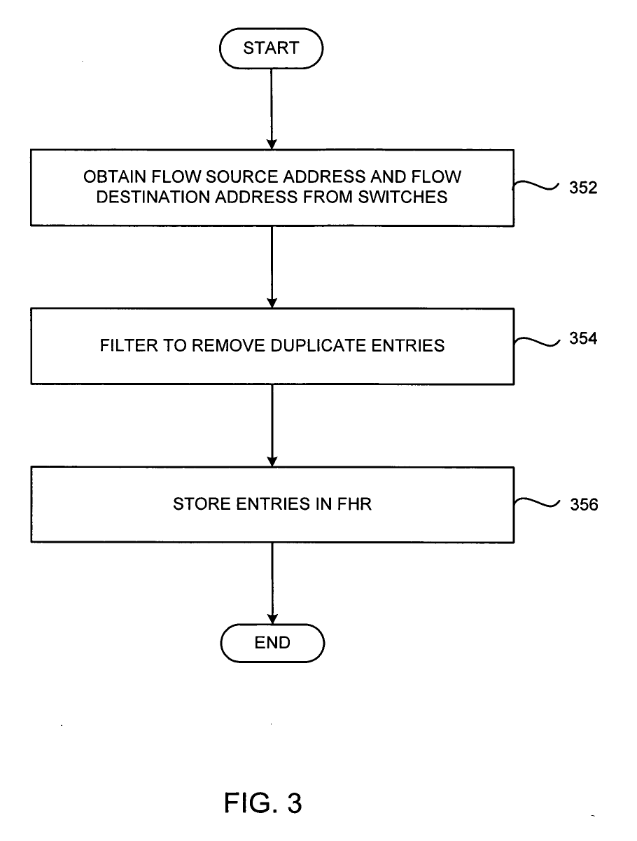

FIG. 3 shows, in accordance with an embodiment of the present invention, a flowchart illustrating the steps to collect, filter and store flow data in a FHR. At step 352, network flow data are collected. Depending on the available capability, the switches may be used to store the flow data for a desired block of time. The periodic collection of data may be performed by pushing the data from the switches up to the NMS or by having the NMS pulling the data from the switches. In a heterogeneous network environment, where switches may not be from the same makes or models, it may be more advantageous to control the flow data collection at the NMS.

At step 354, data entries collected by the NMS may be filtered to remove duplicate data. In an example, multiple switches may handle a data packet before the data packet may be able to reach its destination. When the flow data is gathered by the NMS from the plurality of switches, multiple entries may be sent about the same flow ID. The NMS may filter the data to delete duplicate data entries before saving the data into the FHR (step 356).

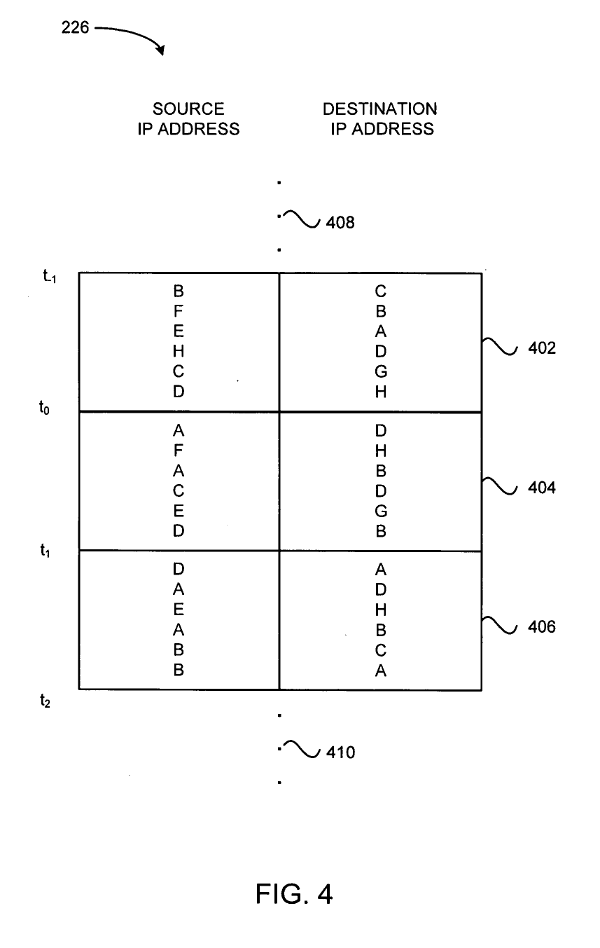

FIG. 4 is discussed in relation to FIG. 2 to illustrate how flow data may be stored on the NMS. FIG. 4 shows, in accordance with an embodiment of the present invention, a diagram illustrating a simple snapshot of blocks of flow data in FHR 226. FHR 226 may include blocks of flow data (sections 402-410). Sections 402-406 may include flow data such as source and destination addresses of nodes in communication sessions during time t₁ (i.e., time minus 1) to time t₂. As previously discussed, the granularity of the collection period may be determined by an administrator. The factors affecting the granularity may be the size of the network, the amount of traffic, and/or the available storage space.

Consider the situation wherein, for example, data are collected during time t₀ to time t₁. During this time, a plurality of conversations may have been conducted by the nodes listed in section 404. A snapshot of the plurality of conversations may be taken and stored on FHR 226. Since the data collected may include multiple incidents of the same flow data, the NMS may remove duplicate entries.

Section 408 represents historical blocks of flow data collected prior to time t₁ (i.e., time minus 1), and section 410 represents blocks of flow data collect after time t₂. Depending on the available storage space, the repository of old flow data may be deleted after a period of time (e.g., seven days). Typically, SRTs may manifest or affect nodes within a few days; therefore, it may not be necessary to keep a repository of data beyond the determined threshold limit to detect and track affected nodes.

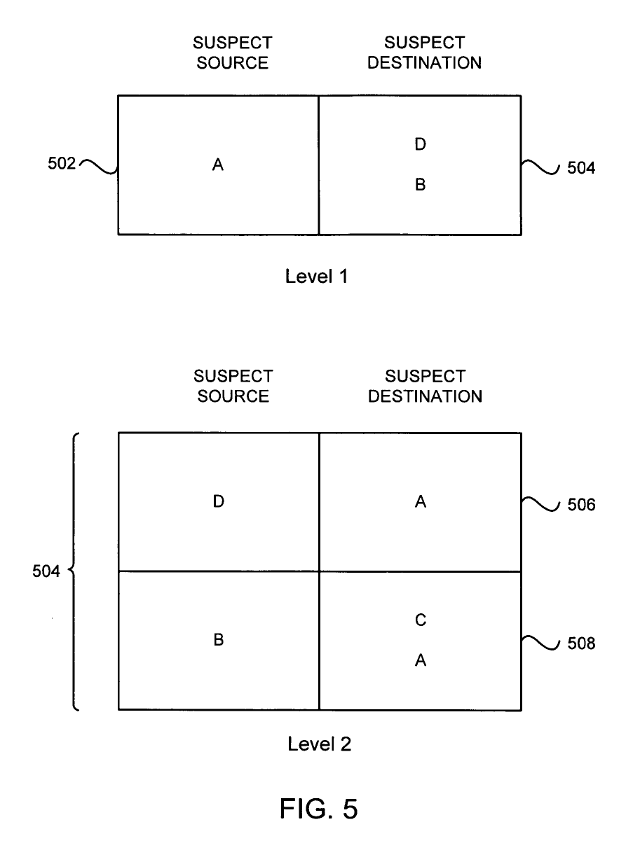

FIG. 5 shows, in accordance with an embodiment of the present invention, a diagram illustrating the suspect source and the affected trail from flow data in the FHR. FIG. 5 will be discussed in relation to FIG. 4. Consider the situation wherein, for example, the suspect source affected by an SRT is node A during a time period between t₀ to time t₂ (sections 404 and 406). Based on the data in FHR 226, suspect node A has been in communication with nodes D and B (section 404) during the suspected time period. At the first level of infection, node A is the suspect source address (section 502) and nodes D and B are the suspect destination addresses (section 504). Once the infected nodes have been identified, corrective actions (e.g., quarantining, notification to network managers and node owners, monitoring of traffic from the nodes, remedial actions to remove SRT) may be implemented accordingly.

Depending upon the severity of the SRT, recursive actions to expand the tracking of the affected trail to identify further suspect nodes may be implemented. In an example, if nodes D and B are suspecting of spreading the SRT, then further research into the FHR may be made to determine which nodes may have communicated with nodes D and B (section 506). In this example, node D has shown to only communicated with node A while node B has shown to have communicated with nodes A and C. Since node A have already been identified and remedial actions have already been applied, only node C may need to be “cleaned.”

Also, recursive actions may not only be applied forward but may also be applied backward (i.e., in reverse) to determine if suspect node A may have been the recipient of the SRT from another node on the network. In an example, suspect node A in a previous time (i.e., t₁ t₀) has shown to be in communication with node E (section 402). If the node has not been infected, then the administrators may have some level of confidence that “patient zero” has been identified. However, if node E is determined to be infected, then remedial action may be applied to node E. Further, additional research may be made to track back as far as necessary to identify other infected nodes and to confirm that “patient zero” has been identified.

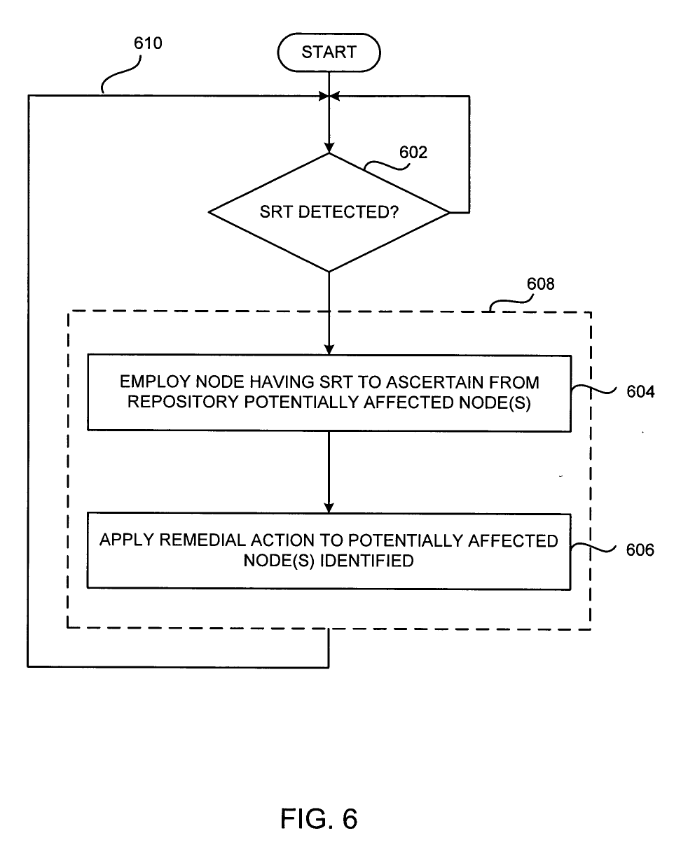

FIG. 6 shows, in accordance with an embodiment of the present invention, a flowchart illustrating how a FHR may be used to track affected trails and to apply remedial action to the affected nodes. With the aid of the FHR, users/administrators may be able to efficiently and accurately determine the affected trail. Thus, the time and effort associated with ascertaining the infected devices may be drastically reduced. In step 602, a monitoring and blocking software (e.g., antivirus program, spyware, or malware program) may check to see if an SRT is detected. If no SRT is detected, the monitoring and blocking software may continue its surveillance.

In an embodiment, the flow data saved in the FHR may be utilized proactively to identify potential SRTs to the nodes in the network. In an example, a node on the network having abnormally high volume of traffic compared to historical traffic volume may indicate a potential attack from an SRT. Another technique may involve randomly examining “top talkers” and periodically funneling their traffic through an intrusion detection system (IDS) to detect affected nodes.

In an embodiment, once a suspect node has been identified as being affected by an SRT, the flow data in the FHR may be utilized to track affected trails (step 604), i.e. other nodes that have been in communication with the affected node. In an example, suspect node A in FIG. 5 has been identified as an affected node and nodes D and B may be tracked through the use of the FHR as being potentially infected.

In an embodiment, the remedial action may be applied to the primary suspect node (i.e., node A) and the nodes that it has been communicating with (i.e., nodes D and B) at step 606. The corrective actions may include, but are not limited to, quarantining, notification to network managers and node owners, monitoring of traffic from the nodes, or direct remedial actions to remove the SRT.

Recursive actions (represented by arrow 610) may be taken to expand the affected trail to identify other suspect nodes (block 608). Returning to step 604, suspect nodes D and B may be analyzed to determine which nodes may have been in communication with suspect nodes D and B during the suspected time period. Once the additional nodes have been identified (i.e., node C of FIG. 5), then remedial action may be taken to eradicate the SRT from node C. The number of recursive steps that may be taken to eliminate the SRT may vary depending upon the severity of the SRT. Similarly these same steps may be taken to identify the nodes that may have sent data packets to the primary suspect node (i.e., node A) to aid in eliminating ‘patient zero.”

As can be appreciated from embodiments of the invention, the FHR transforms a painstaking “search in the haystack” technique, typically utilized by users/administrators to identify SRT infected devices, into an organized forensic analysis of historical flow data. Further, with the present invention, the root cause of the threat may now be identified allowing the users/administrators to determine how the SRTs may have infected the network. By accessing the historical data, the users/administrators may attain a greater understanding of the epidemiology (e.g., rate of spread, operating systems infected, revisions of system infected, infected files, etc.) of different types of SRTs. Thus, the users/administrators may apply preventive measures (e.g., upgrade revisions, change passwords, change write file write access, etc) to mitigate future infections and to curtail and/or minimized unwanted sharing of confidential information, loss of data, and other affiliated disruptions, thereby significantly reducing financial loss for individual users as well as corporate entities.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method of ascertaining an infected node in a network of nodes, comprising:
providing a repository for storing network flow data among at least a plurality of said nodes, said repository being operatively coupled to said network to permit said repository to acquire said network flow data;
storing at said repository first network flow data among said at least a plurality of nodes, said first network flow data including a plurality of source addresses and corresponding destination addresses for a plurality of data flows; and
analyzing said first network flow data at said repository to ascertain communication abnormalities that indicate whether any of said plurality of nodes is infected.

2. The computer-implemented method of claim 1 wherein said storing is performed for different blocks of first network flow data at different periods of time.

3. The computer-implemented method of claim 2 wherein said different blocks of first network flow data are received periodically.

4. The computer-implemented method of claim 1 further comprising ascertaining a first node as an infected node, wherein said analyzing includes performing forward forensic analysis through said first network flow data at said repository from said first node to examine whether nodes that received communication from said first node are also infected.

5. The computer-implemented method of claim 1 further comprising ascertaining a first node as an infected node, wherein said analyzing includes performing backward forensic analysis through said first network flow data at said repository from said first node to examine whether nodes that transmitted information to said first node are also infected.

6. The computer-implemented method of claim 1 wherein said analyzing is performed recursively to follow an affected trail from a given infected node.

7. The computer-implemented method of claim 1 further comprising performing a corrective action upon ascertaining, responsive to said analyzing, that a given node of said plurality of nodes is infected.

8. The computer-implemented method of claim 7 wherein said corrective action includes quarantining said given node.

9. The computer-implemented method of claim 7 wherein said corrective action includes notifying a network operator pertaining to said given node being infected.

10. The computer-implemented method of claim 7 wherein said corrective action includes removing a source of infection in said given node.

11. The computer-implemented method of claim 1 wherein said first network flow data represents a filtered portion of said network flow data.

12. The computer-implemented method of claim 11 wherein said first network flow data represents a subset of said network flow data that has been filtered to remove duplicate entries.

13. The computer-implemented method of claim 1 wherein said network of nodes represents a packet-based network.

14. The computer-implemented method of claim 1 wherein said infected node represents a node that is infected with a self-replicating threat.

15. The computer-implemented method of claim 1 wherein said first network flow data is acquired by said repository.

16. The computer-implemented method of claim 1 wherein said first network flow data is sent to said repository by said at least plurality of nodes.

17. An article of manufacture comprising a program storage medium having computer readable code embodied therein, said computer readable code being configured to ascertain an infected node in a network of nodes, comprising:
computer readable code for storing at a repository first network flow data among said at least a plurality of nodes, said first network flow data including a plurality of source addresses and corresponding destination addresses for a plurality of data flows; and
computer readable code for analyzing said first network flow data at said repository to ascertain communication abnormalities that indicate whether any of said plurality of nodes is infected.

18. The article of manufacture of claim 17 further comprising computer readable code for performing forward forensic analysis through said first network flow data at said repository starting from a first node to examine whether nodes that received communication from said first node are also infected.

19. The article of manufacture of claim 17 further comprising computer readable code for performing backward forensic analysis through said first network flow data at said repository starting from a first node to examine whether nodes that transmitted information to said first node are also infected.

20. The article of manufacture of claim of claim 17 wherein said computer readable code for analyzing includes recursion code to follow an affected trail from a given infected node.

21. The article of manufacture of claim of claim 17 further comprising computer readable code for performing a corrective action upon ascertaining, responsive to said analyzing, that a given node of said plurality of nodes is infected.

22. The article of manufacture of claim of claim 17 wherein said network of nodes represents a packet-based network.

23. The article of manufacture of claim of claim 17 wherein said infected node represents a node that is infected with a self-replicating threat.

24. A network of nodes having threat diagnostic capability for ascertaining an infected node in said network of nodes, comprising:
a repository operatively coupled to said network to permit said repository to acquire said network flow data;
logic circuitry for storing at said repository first network flow data among at least a plurality of nodes of said nodes, said first network flow data including a plurality of source addresses and corresponding destination addresses for a plurality of data flows; and
logic circuitry for analyzing said first network flow data at said repository to ascertain communication abnormalities that indicate whether any of said plurality of nodes is infected.

25. The network claim 24 further comprising logic circuitry for performing forward forensic analysis through said first network flow data at said repository starting from a first node to examine whether nodes that received communication from said first node are also infected.

26. The network claim 24 further comprising logic circuitry for performing for performing backward forensic analysis through said first network flow data at said repository starting from a first node to examine whether nodes that transmitted information to said first node are also infected.

27. The network claim 24 wherein said network of nodes represents a packet-based network.

28. The network claim 24 wherein said infected node represents a node that is infected with a self-replicating threat.
